(19) United States
(12) Patent Application Publication
(10) Pub. No.: US 2003/0213136 A1
(43) Pub. Date: Nov. 20, 2003

(54) Electrical tilt sensor

(76) Inventor: George G. Klock, Scottsdale, AZ (US)

Correspondence Address: Robert Nick, PO Box 3156, Laguna Hills, CA, 92654, US

(21) Appl. No.: 10/147,590

(22) Filed: May 17, 2002

(51) Int. Cl. G01C 9/06

(52) U.S. Cl. 33/366.21

(57) ABSTRACT

A miniature, low cost, angle-sensing device is disclosed. The device comprises a tilt-actuated assembly having a non-mercurial electrically resistive fluid that bridges conductive members when the device is tilted to a desired position to initiate a signal for electronic devices. Embodiments include multi-axis and multiple angle position sensors with or without alert signal means for inverted orientation.

### FIELD OF THE INVENTION

The invention relates to electrical tilt sensors and more particularly to non-mercurial tilt sensor devices.

### BACKGROUND OF THE INVENTION

Electrical tilt sensors and like devices operate to switch electrical circuits on and off as a function of the angle of inclination of the sensor. Such devices normally include a tilt switch with a displaceable electrically conductive element that contacts two or more terminals when the sensor is inclined to an operating position.

Tilt switches employing mercury as the electrically conductive element are well known in the art, as shown for example in U.S. Pat. Nos. 4,201,900 and 4,434,337.

A common mercury tilt switch, comprises a small glass tube containing spaced electrical contacts and a quantity of mercury. As the tube tilts, the mercury bridges the contacts providing a conductive path to complete an electrical circuit.

Although mercury has certain desirable characteristics for tilt sensor applications, it is a highly toxic substance that can threaten public health and the environment. As such, there are a considerable number of governmental regulations controlling the use, storage, and disposal of mercury and, accordingly, it is becoming increasingly difficult to economically manufacture products that include mercury.

A mercury tilt switch effectively operates to switch electrical currents in the amp or milliampere range. The switching of microampere level currents through mercury tilt switches, however, has not been successful to date, because of contaminants that deposit on the surface of the contact electrodes over a period of time, impeding the flow of electrical current flow.

When high currents are passed through the contact electrodes, a contact cleaning action takes place that tends to prevent the buildup of contaminants. For currents of only a few microamperes however, the cleaning action does not take place, and the buildup of contaminants can produce sporadic and unreliable contact continuity, especially when the tilting motion occurs very slowly. In addition, when a mercury tilt switch is placed in an inverted position, contact continuity is lost, limiting the usefulness of the device in specific applications.

Mercury tilt switches are often used in combination with other types of switching devices, such as electrical relays or transistor switch circuits, to control high-level currents through a load. In these applications, a continuous current is provided to the switching device whenever a specific inclination angle is reached. For digital applications, however, it is preferable to produce a logic level signal at a specified angle position, rather than a continuous current.

In order to meet the angle monitoring and control application requirements of single and multiple angle position sensing devices, a tilt sensor needs to be reliable, accurate, and small in size to permit seamless integration with hi-tech electronic chips operating in the microampere or sub-microampere range. Accordingly, the need exists for a compact, accurate, non-mercurial, angle position sensor that can initiate an output signal for electronic and microelectronic devices.

### BRIEF SUMMARY OF THE INVENTION

A miniature, low cost, angle-sensing device is described. The device comprises a tilt actuated conductive liquid sensor, with one or more output terminals, operative to initiate a signal for electronic or microelectronic devices when the sensor is at a specified angular position.

The invention can be housed in a package as small as 5 mm square, and can provide an angle detection accuracy of one tenth of a degree or better.

The sensor contains a non-mercurial, electrically conducting fluid that changes the resistance level between output terminals of the device, when the sensor is in a desired position.

Microampere level currents, sufficient to energize the input gate of a MOSFET semiconductor can be processed by the sensor and higher amplitude currents in the amp range, for example, can be handled by interfacing appropriate control circuitry to the output of the MOSFET.

Embodiments of the invention include sensors in a normally open circuit or a normally conducting state and devices for detecting multiple angle positions.

### BRIEF DESCRIPTION OF THE SEVERAL VIEWS OF THE DRAWING

FIG. 1 is an illustrative view of a normally open angle-sensing device of the invention;

FIG. 2 is an illustrative view of a normally open angle-sensing device of the invention operative at a sixty-degree tilt position;

FIG. 3 is an illustrative view of an angle-sensing device of the invention showing the conductive liquid level sensitivity;

FIG. 4 is an illustrative view of a normally conducting angle-sensing device of the invention;

FIG. 5 is schematic view of associated circuitry for the device of FIG. 4;

FIG. 6 is an illustrative view of a multiple angle-sensing device of the invention; and

FIG. 7 is a schematic view of associated circuitry for the device of FIG. 6.

### DETAILED DESCRIPTION OF THE INVENTION

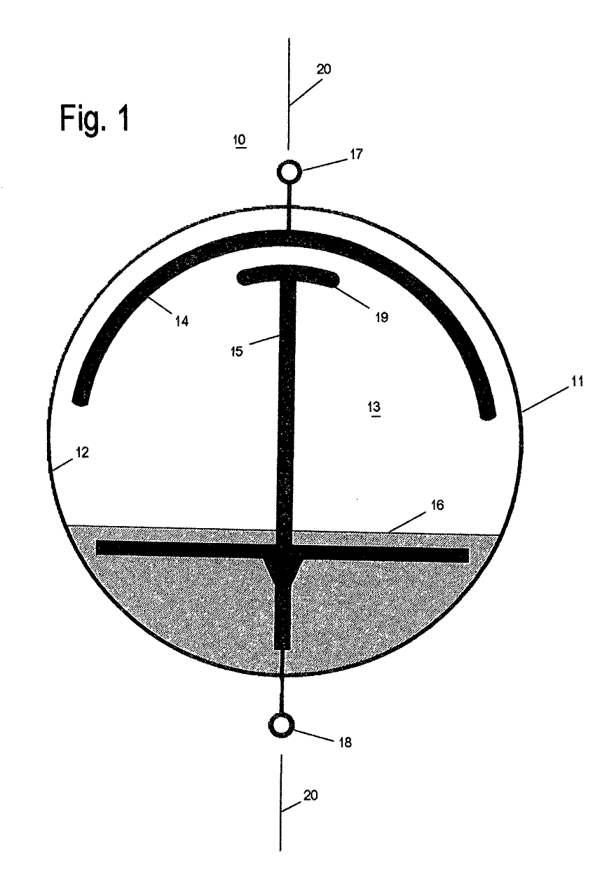

With reference to FIG. 1, a tilt-actuated device 10 of the invention comprises a closed housing containing a first electrically conductive member 14, a second electrically conductive member 15, a first electrical contact 17, a second electrical contact 18, and a non-mercurial electrically conductive fluid 16 having resistive characteristics. The housing can have a cylindrical or spherical shape although other shapes may be used without detracting from the spirit of the invention. A representative housing, having a circular cross-section, is shown in FIG. 1. The housing has an exterior surface 11 and an interior surface 12 defining an interior space 13.

The electrically conductive members are positioned around a central vertical axis 20 of the housing in close proximity to the interior surface 12 and are spatially separated from each other.

The size of the housing, shape and position of the conductive members, are chosen so that the displacement of a minimal volume of fluid is required to bridge the conductive members, when the device is tilted to a specified position. Preferably, the volume of fluid required is less than half of the volume of the interior space.

The characteristics of the conductive fluid are selected to provide a 500K ohm or less resistive path between conductive members and permit the flow of microampere level currents.

A first electrical contact 17 is attached to the exterior surface 11 of the housing and protrudes into the interior space 13 to connect with the first conductive member 14. A second electrical contact 18 is attached to the exterior surface 11 of the housing and protrudes into the interior space 13 to connect with the second conductive member 15. The housing is preferably made from non-conducting material including acrylic or polycarbonate plastics, or ceramics.

The electrically conductive members can be formed from deposited metallic elements or films or from screened materials and are positioned within the housing to make contact with the conductive fluid when the device is placed in a desired angular orientation.

As shown in FIG. 1, one embodiment of the invention has an arc-shaped first conductive member 14 and an extended second conductive member 15 having an arc-shaped end 19 in close proximity with the first conductive member. In operation, the conductive fluid 16 is displaced along the interior surface 12 of the housing and forms a resistive bridge between the first and second conductive members when the device is placed in a desired position. Accordingly, the resistance level between the first and second electrical contacts changes from an essentially open circuit condition to 500K ohms or less, sufficient to energize a MOSFET or other type of semiconductor device.

The conductive fluid solution is chosen to have excellent wetting characteristics and reduced surface tension properties to enable the solution to spread more readily over the interior surface of the housing. A preferable solution has a minimal degradation in conductivity and response time in the temperature range between −40° C. and +85° C., and can be made from inexpensive ingredients.

Suitable ingredients for the solution include, but are not limited to, methyl alcohol, ethyl alcohol, n-isopropyl alcohol, amino acid solutions, sulfuric acid, hydrochloric acid, acetic acid solutions, methylene, silver nitrate, potassium iodide, liquid gallium, gallium alloy, phenol, toluol, ammonia solutions, acetone, magnesium sulfate, sodium chloride, colloidal suspensions, and anti-freeze compositions such as polyethylene glycol.

Suitable solutions having the above stated properties are 95% isopropanol and 5% water or denatured alcohol, 1% silver nitrate dissolved in methanol, water, and butanol, 100% denatured alcohol, and a 50% water-50% automotive antifreeze solution.

A device of the invention, having an angle detection accuracy of one tenth of a degree or better, can be fabricated in a package as small as 5 mm square. To facilitate fabrication, the housing can be made in two parts by sealing a cap assembly, having a conductive element and contact, to the housing using known ultrasonic welding, epoxy, or potting techniques, and inserting the conductive fluid solution in the housing using an injection process.

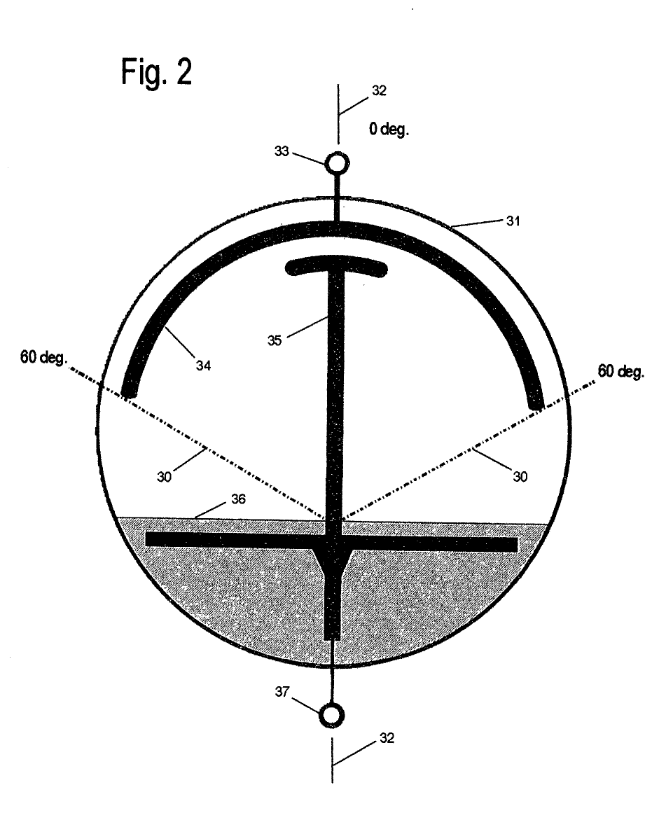

With reference to FIG. 2, the invention of FIG. 1 is illustrated in a vertical or zero degree position with respect to a central axis 32 of the housing 31. In this position, the conductive fluid 36 is in contact with the second electrical conductor 35 only and an open circuit condition exists between the first electrical contact 33 and second electrical contact 37.

When the device is tilted away from a vertical position to a sixty-degree position 30, for example, with respect to the housing central axis, the conductive fluid is sufficiently displaced to bridge the first electrical conductor 34 and second electrical conductor 35. In this state, the fluid provides for a resistive level of 500K ohms or less between the electrical contacts on the housing, sufficient to energize the input circuit of a MOSFET semiconductor.

The invention operates to bridge both conductors when the device is tilted a specified number of degrees in the clockwise or counter-clockwise direction. In addition, the close proximity of the conductive members enables the fluid to effectively bridge both members to establish the required resistance level and provide an alert signal when the device is oriented to an inverted position.

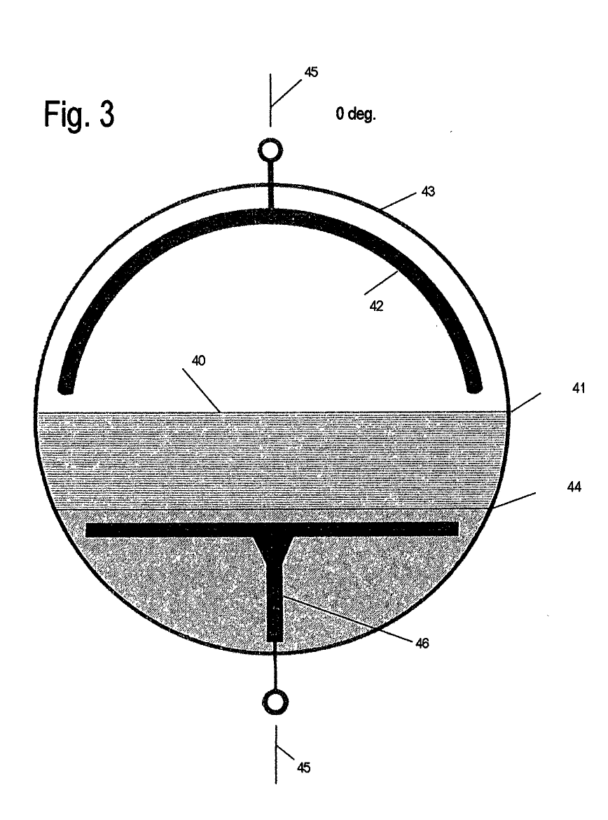

The fluid level in the housing controls the sensitivity of the sensor to angular position changes. With reference to FIG. 3, a device is shown with the housing 43 and the central axis 45 in the vertical or zero degree position. In this position, the device is most sensitive when the conductive fluid 40 is in contact with a first conductive member 46 and the level 41 of the fluid is close to a second conductive member 42. To reduce sensitivity, the liquid level 44 is lowered requiring a greater angular tilt to sufficiently displace the fluid and bridge the conductive members.

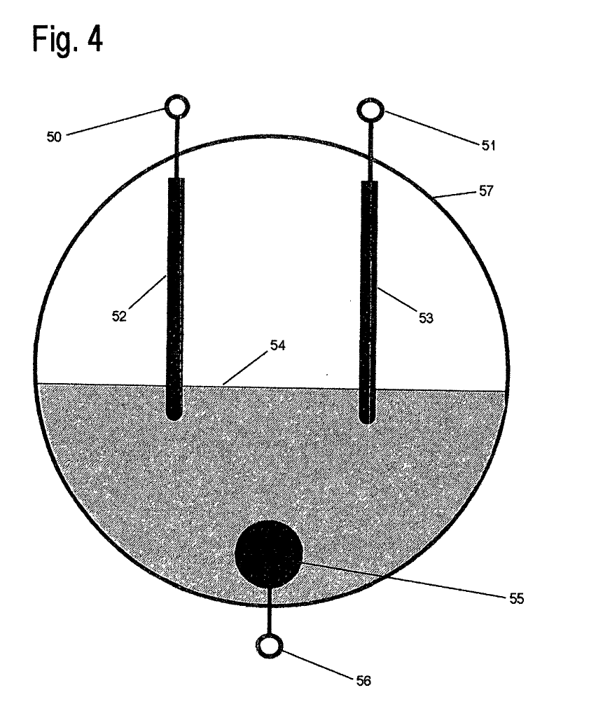

A normally conductive angle-sensing device of the invention is shown in FIG. 4, where, in a non-tilted state, a conductive fluid 54 bridges a first electrical conductor 52 and a second electrical conductor 53 to present a closed circuit resistance level of 500K ohms or less between a first electrical contact 50 and a second electrical contact 51. When the device is tilted in a clockwise or counter-clockwise direction to a selected angular position, the fluid is displaced and does not bridge both electrical conductors producing an open circuit condition between the electrical contacts.

As shown in FIG. 4, a tilt direction indicator can be added by providing a third electrical contact 56 on the housing 57 connected to a third electrical conductor 55. In the non-tilted state, the conductive fluid bridges all three electrical conductors but when the device is tilted in a clockwise direction to a desired angular position, the fluid bridges the second and third conductors only and a resistive path is created between the second contact 51 and the third contact 56. When the device is tilted in a counter-clockwise direction, the fluid bridges the first and third conductors only and a resistive path is created between the first contact and the third contact. Appropriate circuitry can be interfaced to the contacts to indicate the direction of the tilt.

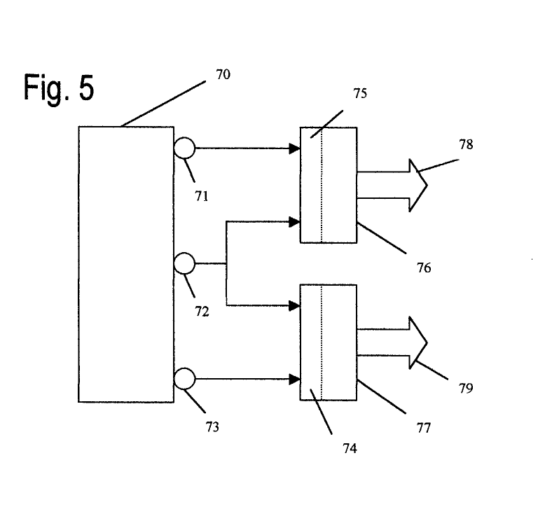

With reference to FIG. 5, tilt direction circuitry for the device 70 of FIG. 4 is shown with the first contact 71 and third contact 72 connected to the gate input circuit 75 of a first MOSFET 76 and the second contact 73 and third contact 72 connected to the gate input circuit 74 of a second MOSFET 77. In operation, the output terminal 78 of the first MOSFET is activated when the device is tilted in a counter-clockwise direction and the output terminal 79 of the second MOSFET is activated when the device is tilted in a clockwise direction.

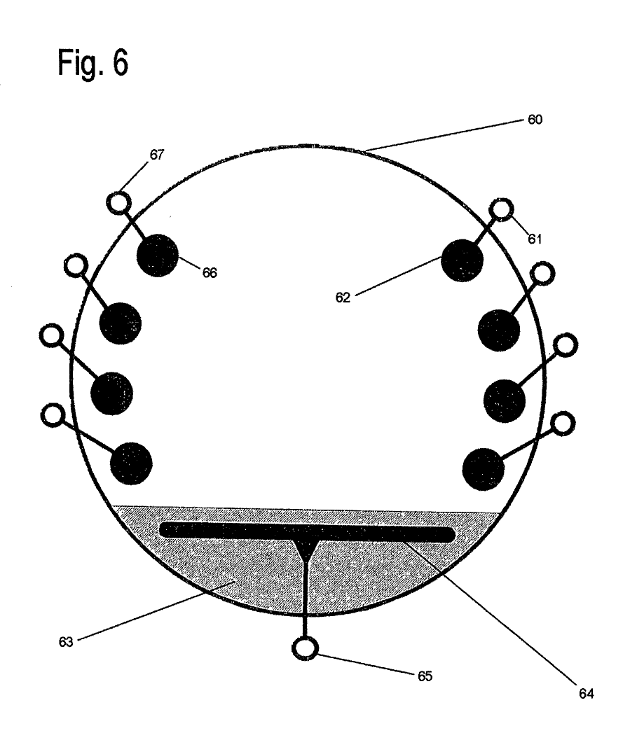

A multiple angle-sensing device of the invention that provides sequential multi-point angle sensing is illustrated in FIG. 6. The device comprises a closed housing 60 containing a conductive fluid 63, a plurality of first electrical conductors 62 and a plurality of second electrical conductors 66 each connected to a corresponding plurality of first electrical contacts 61 and second electrical contacts 67 on the housing respectively. A primary conductor 64 is connected to a primary contact 65 on the housing.

In a non-tilted position, an open circuit condition exists between the primary contact and each electrical contact. When the device is tilted a selected number of degrees, the conductive fluid bridges the primary conductor and one or more electrical conductors to complete a resistive path between the primary contact and the corresponding electrical contacts. As shown in FIG. 6, a counter-clockwise tilt causes the conductive fluid to bridge one or more of the second electrical conductors and a clockwise tilt causes the fluid to bridge one or more of the first electrical conductors. Appropriate circuitry can be interfaced to the contacts to indicate the angular position and direction of the tilt.

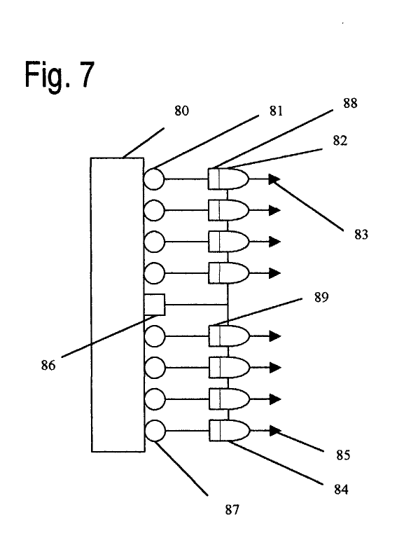

With reference to FIG. 7, angular position and tilt direction indicator circuitry for the sensor 80 of FIG. 6 is shown with a primary contact 86, a plurality of first electrical contacts 81, connected to the gate input circuit 88 of a plurality of corresponding first MOSFET elements 82, and a plurality of second electrical contacts 87, connected to the gate input circuit 89 of a plurality of corresponding second MOSFET elements 84.

In operation, the output 83 of each first MOSFET element 82 is activated sequentially as the device is tilted in a clockwise direction, and the output 85 of each second MOSFET element 84 is activated sequentially as the device is tilted in a counter-clockwise direction, providing an indication of the angular position and tilt direction of the sensor.

Single axis devices of the invention are disclosed herein to detect angular tilt with respect to a vertical axis. Using several of the single axis devices shown in FIG. 1, positioned at right angles to each other, the invention can detect angular increments along multiple axes. Additional embodiments of the invention can include integrated angle-sensing and electronic devices.

Although the various features of novelty that characterize the invention have been described in terms of certain preferred embodiments, other embodiments will become apparent to those of ordinary skill in the art, in view of the disclosure herein. Accordingly, the present invention is not limited by the recitation of the preferred embodiments, but is instead intended to be defined solely by reference to the appended claims.

What is claimed is:

1. A tilt-actuated device comprising:
a housing having an exterior surface and an interior surface defining an enclosed interior space, said enclosed interior space containing a first electrically conductive member, a second electrically conductive member, and a non-mercurial electrically conductive fluid having resistive characteristics;
a first electrical contact attached to said exterior surface and protruding into said interior space, said first electrical contact connected to said first electrically conductive member; and
a second electrical contact attached to said exterior surface and protruding into said interior space, said second electrical contact connected to said second electrically conductive member whereby said electrically conductive fluid is displaced along said interior surface to form a resistive bridge of 500K ohms or less between said electrically conductive members changing the resistance level between said first and said second electrical contacts from an open circuit state condition to a resistive state condition when said tilt actuated device is oriented to a specified position.

2. The device of claim 1 wherein said fluid bridges said electrically conductive members to provide an alert signal when said device is oriented to an inverted position.

3. The device of claim 1 wherein said fluid bridges said electrically conductive members when said device is tilted to a specified position in a clockwise direction.

4. The device of claim 1 wherein said fluid bridges said electrically conductive members when said device is tilted to a specified position in a counter-clockwise direction.

5. The device of claim 1 wherein the volume of said fluid is less than half of the volume of said enclosed interior space.

6. The electrically conductive fluid of claim 1 wherein said fluid has wetting and surface tension characteristics to readily spread said fluid over said interior surface.

7. The electrically conductive fluid of claim 1 selected from the group consisting of 95% isopropanol and 5% water, 95% isopropanol and 5% denatured alcohol, 1% silver nitrate dissolved in methanol, 1% silver nitrate dissolved in water, 1% silver nitrate dissolved in butanol, 100% denatured alcohol and a 50% water and 50% automotive antifreeze solution.

8. The electrically conductive members of claim 1 formed from deposited metallic elements.

9. The electrically conductive members of claim 1 formed from deposited films.

10. The electrically conductive members of claim 1 formed from screened materials.

11. The housing of claim 1 made of non-conducting materials.

12. The housing of claim 1 made of materials selected from the group consisting of acrylic plastic, polycarbonate plastic and ceramics.

13. A tilt-actuated device comprising:
a housing having an exterior surface and an interior surface defining an enclosed interior space, said enclosed interior space containing a first electrically conductive member, a second electrically conductive member, and a non-mercurial electrically conductive fluid having resistive characteristics;
a first electrical contact attached to said exterior surface and protruding into said interior space, said first electrical contact connected to said first electrically conductive member;
a second electrical contact attached to said exterior surface and protruding into said interior space, said second electrical contact connected to said second electrically conductive member whereby said electrically conductive fluid forms a resistive bridge of 500K ohms or less between said electrically conductive members when said tilt-actuated device is not tilted, said fluid being displaced to form an open circuit condition between said conductive members when said tilt actuated device is oriented to a specified position thereby changing the resistance level between said electrical contacts from a resistive state condition to an open circuit condition.

14. A tilt-direction indicator device comprising:
a housing having an exterior surface and an interior surface defining an enclosed interior space, said enclosed interior space containing a first electrically conductive member, a second electrically conductive member, a third electrically conductive member, and a non-mercurial electrically conductive fluid having resistive characteristics;
a first electrical contact attached to said exterior surface and protruding into said interior space, said first electrical contact connected to said first electrically conductive member;
a second electrical contact attached to said exterior surface and protruding into said interior space, said second electrical contact connected to said second electrically conductive member;
a third electrical contact attached to said exterior surface and protruding into said interior space, said third electrical contact connected to said third electrically conductive member;
whereby said electrically conductive fluid forms a resistive bridge of 500K ohms or less between said first, said second, and said third electrically conductive members when said tilt-direction device is not tilted, said fluid being displaced to bridge said second and third conductors only when said device is tilted in a clockwise direction to a desired angular position, said fluid being displaced to bridge said first and said third conductors only when said device is tilted in a counter-clockwise direction to a desired angular position whereby a resistive path is created between said second and third conductors only when said device is tilted in a clockwise direction and a resistive path is created between said first and third conductors only when said device is tilted in a counter-clockwise direction thereby providing an indication of the direction that said device is tilted.

15. An electrical circuit for indicating the angular tilt direction of a device comprising:
an electrical tilt sensor having three output terminals said sensor operative to change the resistive path between a first pair of said output terminals when said sensor is tilted in a clockwise direction and operative to change the resistive path between a second pair of said output terminals when said sensor is tilted in a counter-clockwise direction;
a first MOSFET having a gate input circuit and an output terminal said gate input circuit connected to said first pair of sensor output terminals; and
a second MOSFET having a gate input circuit and an output terminal said second MOSFET gate input circuit connected to said second pair of sensor output terminals whereby the output terminal of said first MOSFET is activated when said device is tilted in a clockwise direction and the output terminal of said second MOSFET is activated when said device is tilted in a counter-clockwise direction.

16. A multiple angle sensing device providing sequential multi-point angle sensing comprising:
a closed housing containing a conductive fluid having resistive characteristics;
a plurality of first electrical conductors within said housing said first electrical conductors connected to a corresponding plurality of first electrical contacts on said housing;
a plurality of second electrical conductors within said housing said second electrical conductors connected to a corresponding plurality of second electrical contacts on said housing; and
a primary electrical conductor within said housing said primary electrical conductor connected to a primary electrical contact on said housing whereby said conductive fluid forms a resistive bridge of 500K ohms or less between said primary electrical conductor and one or more of said first electrical conductors when said sensing device is tilted in a clockwise direction to a desired angular position and said conductive fluid forms a resistive bridge of 500K ohms or less between said primary electrical conductor and one or more of said second electrical conductors when said sensing device is tilted in a counter-clockwise direction to a desired angular position.

17. An electrical circuit for indicating the angular position and tilt direction of a device comprising:
a multiple angle sensing device providing sequential multi-point angle sensing having a plurality of first electrical contacts, a plurality of second electrical contacts and a primary electrical contact said sensor operative to sequentially change the resistive path between said primary electrical contact and one or more of said first electrical contacts when said sensing device is tilted in a clockwise direction to a desired position and operative to sequentially change the resistive path between said primary electrical contact and one or more of said second electrical contacts when said sensing device is tilted in a counter-clockwise direction to a desired position;
a plurality of first MOSFET elements having corresponding input and output terminals said plurality of first MOSFET input terminals correspondingly connected to said plurality of said first electrical contacts; and
a plurality of second MOSFET elements having corresponding input and output terminals said plurality of said second MOSFET input terminals correspondingly connected to said plurality of said second electrical contacts whereby the output terminals of said first MOSFET elements are activated when said multiple angle sensing device is tilted in a clockwise direction and the output terminals of said second MOSFET elements are activated when said multiple angle sensing device is tilted in a counter-clockwise direction.
